(19) United States
(12) Patent Application Publication
(10) Pub. No.: US 2019/0361133 A1
(43) Pub. Date: Nov. 28, 2019

(54) PHOTOELECTRIC DETECTION STRUCTURE AND PREPARATION METHOD THEREOF

(71) Applicant: IRAY TECHNOLOGY COMPANY LIMITED, SHANGHAI (CN)

(72) Inventor: LIBO JIN, SHANGHAI (CN)

(73) Assignee: IRAY TECHNOLOGY COMPANY LIMITED, SHANGHAI (CN)

(21) Appl. No.: 15/990,780

(22) Filed: May 28, 2018

(51) Int. Cl. G01T 1/20

(52) U.S. Cl. CPC G01T 1/2018; G01T 1/2002

(57) ABSTRACT

A photoelectric detection structure and a preparation method, the structure comprises a first scintillator layer used for absorbing low-energy X rays and converting the X rays into visible light; a second scintillator layer used for absorbing high-energy X rays and converting the X rays into visible light; and a first visible light sensor located between the first scintillator layer and the second scintillator layer and used for converting visible light penetrating through the first scintillator layer and visible light reflected by the second scintillator layer into charges and storing the charges into the first visible light sensor. The method comprises providing a substrate, preparing layers layer by layer on the substrate through a semiconductor manufacturing process to form a first visible light sensor, forming a first scintillator layer on a first surface of the first visible light sensor and then forming a second scintillator layer on a second surface of the first visible light sensor.

### BACKGROUND OF THE PRESENT INVENTION

### Field of Invention

The present invention relates to the field of medical imaging diagnosis, in particular to a photoelectric detection structure and a preparation method thereof

### Description of Related Arts

Flat-panel image sensors are usually applied to fields such as of medical radiation imaging, industrial flaw detection and security inspection. Flat-panel image sensors, especially large-size image sensors, usually have a size of several tens of centimeters and several millions to ten millions of pixels. In application of X-ray image detectors, it is generally required that the area reaches 43 cm*43 cm. Therefore, at present, the amorphous silicon technology is always adopted (monocrystalline silicon detectors generally have diameter of 24-30 cm at present).

As illustrated in FIG. 1, a currently used amorphous silicon flat-panel detector is usually a multilayer stack structure and comprises upper-layer scintillators for converting incident X rays into visible light. Visible light irradiates a lower-layer visible light sensor and the visible light sensor converts visible light into electrons. This structure has the problem that the absorption of most X rays in substances occurs near an incidence surface, but the produced visible light is in any direction. Since the absorption of X rays in scintillators for light emission is mainly centralized in the incidence surface, the position at which the visible light is intensively produced is near the upper surface. A visible light emitting point is far from the visible light sensor below, the long transmission distance causes divergence of the visible light, which will consequently result in crosstalk of adjacent pixels and image blurred.

In order to solve the above-mentioned problem, patent EP2902807A1 provides a new structure. As illustrated in FIG. 2, an upper portion 20 comprises scintillators; and a lower portion is a TFT sensor, the function of which is the same as that of the visible light sensor as illustrated in FIG. 1, i.e., to convert visible light produced by the scintillators into electrons. Differently, an incidence plane of X rays in this patent is a TFT sensor plane instead of a scintillator plane. Therefore, after penetrating through the TFT sensor, the X rays irradiate the scintillators and are centralized near a contact interface between the scintillators and the TFT sensor. Since the position at which the visible light is produced is very close to the position of the TFT sensor which receives the visible light, the divergence of the visible light is decreased and thus the definition of the images is improved. However, this solution still has another problem that, when high-energy rays with stronger permeability irradiate, the incidence depth of the rays is increased; and when the energy of the rays reaches a certain extent, the incidence depth can reach a position far away from the surface of the TFT sensor and the problem of divergence of visible light still exists.

Therefore, how to effectively solve the divergence of visible light in the flat-panel image sensor, decrease the crosstalk and improve the light responsivity has become one of problems which need to be urgently solved by one skilled in the art.

### SUMMARY OF THE PRESENT INVENTION

In view of the disadvantages of the prior art, the purpose of the present invention is to provide a photoelectric detection structure and a method for preparing the same, which are used for solving the problems such as of divergence of visible light, influences caused by crosstalk to image quality and low light responsivity in the prior art.

In order to realize the above-mentioned purpose and other related purposes, the present invention provides a photoelectric detection structure, and the photoelectric detection structure at least comprises:

a first scintillator layer used for absorbing low-energy X rays and converting the X rays into visible light;

a second scintillator layer used for absorbing high-energy X rays and converting the X rays into visible light; and

a first visible light sensor located between the first scintillator layer and the second scintillator layer and used for converting visible light penetrating through the first scintillator layer and visible light reflected by the second scintillator layer into charges and storing the charges into the first visible light sensor.

Preferably, a material of the first scintillator layer and the second scintillator layer is cesium iodide or gadolinium oxysulfide.

Preferably, the first visible light sensor comprises a substrate and a plurality of pixel units arranged on the substrate in a two-dimensional array; each pixel unit comprises a thin film transistor and a PIN photodiode; and the substrate and a top electrode and a bottom electrode of the PIN photodiode are made of a transparent or semitransparent material.

More preferably, the thin film transistor and the PIN photodiode are provided in a non-overlapped manner on a vertical plane of incidence of the X rays.

More preferably, the thickness of the substrate is set to be 15 μm-50 μm.

More preferably, the substrate is a fiber optical plate and a plurality of fiber optical catheters perpendicular to a surface are provided in the fiber optical plate.

More preferably, the substrate is made of a material with density not greater than 3 g/cm³.

More preferably, the material of the substrate is polyimide, plastic, or silicon.

Preferably, the photoelectric detection structure further comprises a second visible light sensor located in a lower layer of the second scintillator layer and used for converting visible light penetrating through the second scintillator layer into charges and storing the charges into the second visible light sensor.

In order to realize the above-mentioned purpose and other related purposes, the present invention further provides a preparation method for the photoelectric detection structure, and the method at least comprises:

providing a substrate, preparing all material layers layer by layer on the substrate to form a first visible light sensor, forming a first scintillator layer on a first surface of the first visible light sensor and then forming a second scintillator layer on a second surface of the first visible light sensor.

Preferably, the first scintillator layer and the second scintillator layer are bonded to the surfaces of the first visible light sensor through optical coupling adhesive.

Preferably, the first scintillator layer and the second scintillator layer are formed by means of film coating.

As described above, the photoelectric detection structure and the preparation method thereof provided by the present invention have the following beneficial effects:

The photoelectric detection structure and the preparation method thereof provided by the present invention can realize better image definition (decrease light divergence) and simultaneously can realize higher light responsivity (conversion efficiency).

### BRIEF DESCRIPTION OF THE DRAWINGS

FIG. 1 illustrates a structural schematic view of an amorphous silicon flat-panel detector in the prior art.

FIG. 2 illustrates a structural schematic view of an amorphous silicon flat-panel detector capable of decreasing divergence of visible light in the prior art.

FIG. 3 illustrates one embodiment of a photoelectric detection structure provided by the present invention.

FIG. 4 illustrates another embodiment of a photoelectric detection structure provided by the present invention.

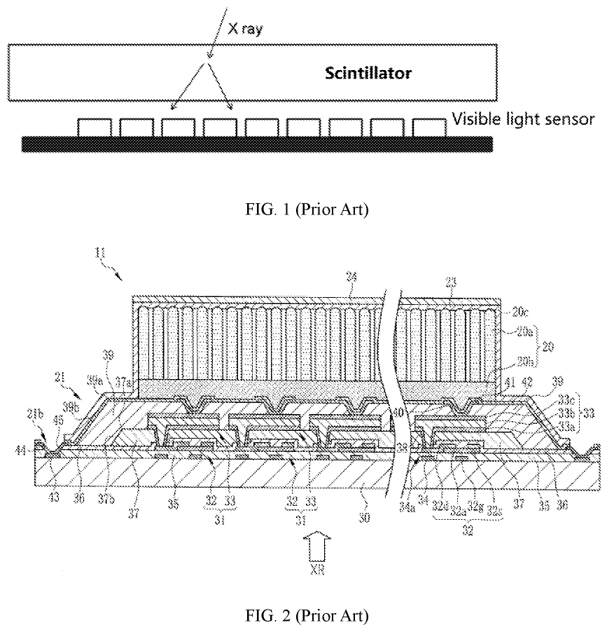

### DESCRIPTION OF COMPONENT MARK NUMBERS

5 Photoelectric detection structure
51 First scintillator layer
52 First visible light sensor
521 Substrate
522 Amorphous silicon
523 Drain terminal
524 Gate terminal
525 Source terminal
526 PIN photodiode
527 Bottom electrode
528 Top electrode
529 Offset line
53 Second scintillator layer
S1-S2 Steps

### DETAILED DESCRIPTION OF THE PREFERRED EMBODIMENTS

The implementation modes of the present invention will be described below through specific examples. One skilled in the art can easily understand other advantages and effects of the present invention according to content disclosed in the description. The present invention may also be implemented or applied through other different specific implementation modes. Various modifications or variations may be made to all details in the description based on different points of view and applications without departing from the spirit of the present invention.

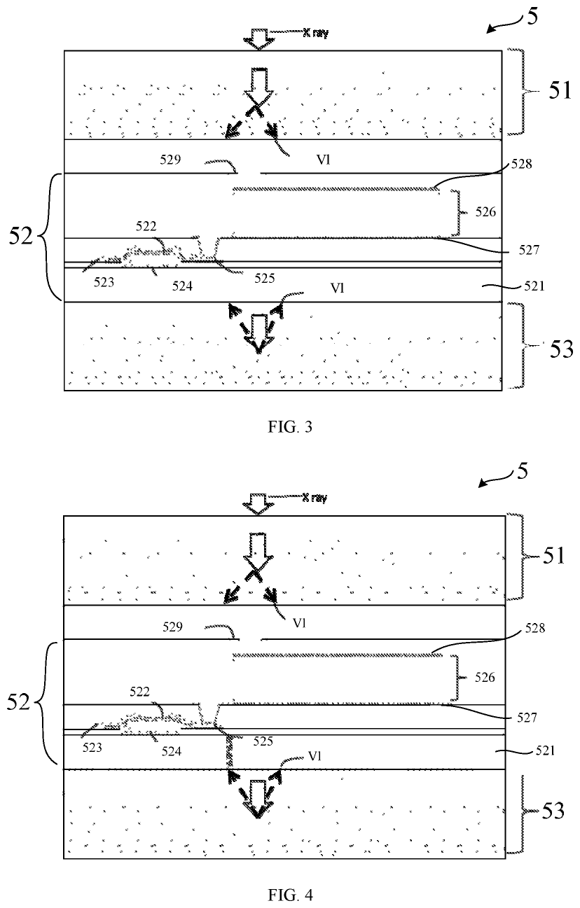

Please refer to FIG. 3 to FIG. 4. It needs to be stated that the drawings provided in the following embodiments are just used for schematically describing the basic concept of the present invention, thus only illustrate components only related to the present invention and are not drawn according to the numbers, shapes and sizes of components during actual implementation, the configuration, number and scale of each component during actual implementation thereof may be freely changed, and the component layout configuration thereof may be more complex.

### Embodiment 1

As illustrated in FIG. 3, the present invention provides a photoelectric detection structure 5, and the photoelectric detection structure 5 at least comprises:

a first scintillator layer 51, a first visible light sensor 52 and a second scintillator layer 53.

As illustrated in FIG. 3, the first scintillator layer 51 is located on an X ray receiving plane of the photoelectric detection structure 5 and is used for absorbing low-energy X rays and converting the X rays into visible light V1, and the visible light V1 becomes emergent from the first scintillator layer 51 and is detected by the first visible light sensor 52.

Specifically, a material of the first scintillator layer 51 includes but not limited to cesium iodide or gadolinium oxysulfide, any material which can convert X rays into visible light is applicable to the present invention and the material is not limited to this embodiment.

As illustrated in FIG. 3, the second scintillator layer 53 is located inside the photoelectric detection structure 5 and is used for absorbing high-energy X rays and converting the X rays into visible light.

Specifically, a material of the second scintillator layer 53 includes but not limited to cesium iodide or gadolinium oxysulfide, any material which can convert X rays into visible light is applicable to the present invention and the material is not limited in this embodiment. X rays pass through the first scintillator layer 51, the low-energy part thereof is absorbed and converted by the first scintillator layer 51, the high-energy part thereof penetrates through the first scintillator layer 51 and the first visible light sensor 52 and is absorbed by the second scintillator layer 53, the high-energy X rays are converted into visible light, the visible light V1 is reflected and then is detected by the first visible light sensor 52.

More specifically, a sum of the thickness of the first scintillator layer 51 and the thickness of the second scintillator layer 53 is substantially consistent with the thickness of the single-layer scintillator layer in the prior art, which is set to be within 1 mm, and the thickness is different when different materials are used. In this embodiment, when the cesium iodide material is adopted, the sum of the thickness of the first scintillator layer 51 and the thickness of the second scintillator layer 53 is 0.2 mm-0.3 mm, and when the gadolinium oxysulfide material is adopted, the sum of the thickness of the first scintillator layer 51 and the thickness of the second scintillator layer 53 is 0.6 mm. One skilled in the art may set the thickness according to different materials and the thickness is not limited to this embodiment.

As illustrated in FIG. 3, the first visible light sensor 52 is located between the first scintillator layer 51 and the second scintillator layer 53 and is used for converting visible light penetrating through the first scintillator layer 51 and visible light reflected by the second scintillator layer 52 into electric charges and storing the charges into the first visible light sensor 52.

Specifically, as illustrated in FIG. 3, the first visible light sensor 52 comprises a substrate 521 and a plurality of pixel units arranged on the substrate 521 in a two-dimensional array.

More specifically, in this embodiment, in order to guarantee that the visible light produced by the second scintillator layer 53 can irradiate the PIN photodiode 526, the substrate 521 is made of a transparent or semitransparent material. The substrate 521 is made of a thin material to reduce divergence of visible light. In this embodiment, the thickness of the substrate 521 is 15 um-50 um and should be smaller than ⅓ of the size of the pixel. Moreover, in order to reduce the absorption of X rays by the substrate 521, the material of the substrate 521 should be a low-density and low-atomic-coefficient material, and the substrate 521 should be made of a material with density not greater than 3 g/cm³, including but not limited to PI (polyimide), plastic and silicon.

More specifically, each pixel unit comprises a thin film transistor and a PIN photodiode 526. The thin film transistor (TFT) comprises amorphous silicon 522, a drain terminal 523, a gate terminal 524 and a source terminal 525, and the thin film transistor is conducted by controlling the voltage of the gate terminal 524 to realize a switching function. In order to reduce parasitic resistance, the drain terminal 523, the gate terminal 524 and the source terminal 525 are made of metal materials, including but not limited to metals such as aluminum and molybdenum. The PIN photodiode 526 sequentially comprises a P-type doping region, an intrinsic region and an N-type doping region, a bottom electrode 527 is provided at the lower layer, a top electrode 528 is provided at the upper layer, an offset line 529 is provided on the top electrode 528, and the operation that the PIN photodiode 526 absorbs visible light and converts the visible light into charges is mainly completed in the intrinsic region. In order to guarantee that the visible light produced by the second scintillator layer 53 can irradiate the PIN photodiode 526, the bottom electrode 527 and the top electrode 528 are made of a transparent or semitransparent material. In this embodiment, the bottom electrode 527 and the top electrode 528 are made of ITO (indium tin oxide semiconductor transparent conductive film). As illustrated in FIG. 3, the thin film transistor and the PIN photodiode 526 are provided in a non-overlapped manner on a vertical plane of incidence of the X rays, so as to decrease the influence of the thin film transistor on the absorption of the visible light by the PIN photodiode 526.

By adopting two scintillator layers in the present invention, on the premise that the total thickness and the total absorption and conversion efficiency are guaranteed to be the same as that of the single scintillator layer, the transmission distance for visible light production is decreased, the divergence of visible light is reduced, the light permeation rate is increased and the image definition is improved.

### Embodiment 2

This embodiment provides a photoelectric detection structure, which is substantially the same as the structure in embodiment 1, the difference lies in that the substrate 521 is a fiber optical plate.

Specifically, as illustrated in FIG. 4, a plurality of fiber optical catheters perpendicular to a surface are provided in the fiber optical plate, the visible light produced by the second scintillator layer 53 is refracted to the first visible light sensor 52 through the fiber optical catheters and is absorbed, and thus the divergence of visible light can be effectively decreased.

### Embodiment 3

This embodiment provides a photoelectric detection structure, which is substantially the same as the structures in embodiment 1 and embodiment 2, the difference lies in that the lower layer of the second scintillator layer 53 further comprises a second visible light sensor (not shown) used for converting visible light penetrating through the second scintillator layer 53 into charges and storing the charges into the second visible light sensor.

Further, an extension may also be made to obtain an alternative distribution structure of a plurality of scintillator layers and a plurality of visible light sensors. The more the number of layers is, the shorter the passage of visible light is, the smaller the divergence of light is, the clearer the image is. Moreover, independent visible light sensors are used for different scintillator layers, the energy of X rays is higher, the irradiation depth is greater and thus multi-energy-level X ray detection can be achieved.

### Embodiment 4

The present invention further provides a preparation method for a photoelectric detection structure 5, and the method at least comprises the following steps:

In step S1, a substrate is provided and material layers are prepared layer by layer on the substrate through a semiconductor manufacturing process to form a first visible light sensor.

Specifically, in this embodiment, the substrate 521 is a fiber optical plate. A material layer of a gate terminal 524 is deposited on a surface of the substrate 521. In this embodiment, material layers are formed by adopting a physical vapor deposition method, the materials layers may be formed by adopting any method in a specific preparation process and it is not limited to this embodiment. Then, the gate terminal 524 and relevant metal connecting lines are formed through exposure and etching; amorphous silicon 522, a drain terminal 523 and a source terminal 525 are formed sequentially by adopting the same method; and thereby the thin film transistor is formed. A metal layer of the bottom electrode 527 of the PIN photodiode 526 is deposited, similarly a bottom electrode 527 and relevant metal connecting lines are formed through exposure and etching, and the PIN photodiode 526 is connected with the thin film transistor through the bottom electrode 527; and an N-type doping region, an intrinsic region and a P-type doping region, a top electrode 528 and an offset line 529 of the PIN photodiode 526 are formed sequentially by adopting the same method, so as to form the PIN photodiode 526. A protection layer is coated onto the offset line 529 and the preparation of the first visible light sensor 52 is completed.

If PI is selected as the material of the substrate 521, PI needs to be coated onto glass, and after the preparation of the first visible light sensor 52 is completed, the first visible light sensor 52 is peeled off from the glass.

In step S2, a first scintillator layer 51 is formed on a first surface of the first visible light sensor 52 and then a second scintillator layer 53 is formed on a second surface of the first visible light sensor 52.

As one embodiment of the present invention, the first scintillator layer 51 and the second scintillator layer 53 are bonded to the surfaces of the first visible light sensor 52 through optical coupling adhesive.

Specifically, the first scintillator layer 51 and the second scintillator layer 53 are provided. Since the protection layer of the first visible light sensor 52 is very thin, which is generally at a μm level, it is easily damaged and is not suitable to pick up by using a robotic arm, the first scintillator layer 51 is bonded to the first surface of the first visible light sensor 52 through optical coupling adhesive, thus the substrate 521 and the first scintillator layer 51 are respectively located on the two sides of the first visible light sensor 52, the thickness is greatly increased relative to the protection layer of the first visible light sensor 52, and it can be directly grabbed through the robotic arm without damaging the device in the first visible light sensor 52. Then, the first scintillator layer 51 and the first visible light sensor 52 which have already been bonded are directly grabbed through the robotic arm, and the second scintillator layer 53 is bonded to the second surface of the first visible light sensor 52 through optical coupling adhesive. The first surface and the second surface of the first visible light sensor 52 are arranged oppositely. In this embodiment, the first surface of the first visible light sensor 52 is a pixel unit surface and the second surface is a substrate surface.

As another embodiment of the present invention, the first scintillator layer 51 and the second scintillator layer 53 are formed on the surfaces of the first visible light sensor 52 by means of film coating. Other steps are the same as the steps in the above-mentioned implementation mode and thus are not repetitively described here anymore.

The second visible light sensor is formed through the same method and specific steps are not repetitively described here anymore.

As described above, the photoelectric detection structure and the method for preparing the same provided by the present invention have the following beneficial effects:

The photoelectric detection structure and the preparation method thereof provided by the present invention increase image definition through the design of two-layer scintillators under high-energy rays, and simultaneously can effectively shorten the escape path of visible light, decrease the absorbed amount and improve the conversion efficiency since the thickness of a single layer of scintillators is smaller than the thickness of the scintillators in the prior art.

To sum up, the present invention provides a photoelectric detection structure, comprising: a first scintillator layer used for absorbing low-energy X rays and converting the X rays into visible light; a second scintillator layer used for absorbing high-energy X rays and converting the X rays into visible light; and a first visible light sensor located between the first scintillator layer and the second scintillator layer and used for converting visible light penetrating through the first scintillator layer and visible light reflected by the second scintillator layer into charges and storing the charges into the first visible light sensor. The present invention further provides a preparation method, comprising: providing a substrate, preparing all material layers layer by layer on the substrate through physical vapor deposition to form a first visible light sensor, forming a first scintillator layer on a first surface of the first visible light sensor and then forming a second scintillator layer on a second surface of the first visible light sensor. The photoelectric detection structure and the method for preparing the same provided by the present invention increase image definition through the design of two-layer scintillators under high-energy rays, and simultaneously can effectively shorten the escape path of visible light, decrease the absorbed amount and improve the conversion efficiency since the thickness of a single layer of scintillators is smaller than the thickness of the scintillators in the prior art. Therefore, the present invention effectively overcomes various disadvantages in the prior art and thus has a great industrial utilization value.

The above-mentioned embodiments are just used for exemplarily describing the principle and effect of the present invention instead of limiting the present invention. One skilled in the art may make modifications or changes to the above-mentioned embodiments without departing from the spirit and scope of the present invention. Therefore, all equivalent modifications or changes made by those who have common knowledge in the art without departing from the spirit and technical thought disclosed by the present invention shall be still covered by the claims of the present invention.

What is claimed is:

1. A photoelectric detection structure, characterized in that the photoelectric detection structure at least comprises:
a first scintillator layer used for absorbing low-energy X rays and converting the X rays into visible light;
a second scintillator layer used for absorbing high-energy X rays and converting the X rays into visible light; and
a first visible light sensor located between the first scintillator layer and the second scintillator layer and used for converting visible light penetrating through the first scintillator layer and visible light reflected by the second scintillator layer into charges and storing the charges into the first visible light sensor.

2. The photoelectric detection structure according to claim 1, characterized in that a material of the first scintillator layer and the second scintillator layer is cesium iodide or gadolinium oxysulfide.

3. The photoelectric detection structure according to claim 1, characterized in that the first visible light sensor comprises a substrate and a plurality of pixel units arranged on the substrate in a two-dimensional array; each pixel unit comprises a thin film transistor and a PIN photodiode; and the substrate and a top electrode and a bottom electrode of the PIN photodiode are made of a transparent or semitransparent material.

4. The photoelectric detection structure according to claim 3, characterized in that the thin film transistor and the PIN photodiode are provided in a non-overlapped manner on a vertical plane of incidence of the X rays.

5. The photoelectric detection structure according to claim 3, characterized in that the thickness of the substrate is 15 μm-50 μm.

6. The photoelectric detection structure according to claim 3, characterized in that the substrate is a fiber optical plate, and a plurality of fiber optical catheters perpendicular to a surface are provided in the fiber optical plate.

7. The photoelectric detection structure according to claim 3, characterized in that the substrate is made of a material with density not greater than 3 g/cm³.

8. The photoelectric detection structure according to claim 7, characterized in that the material of the substrate is polyimide, plastic or silicon.

9. The photoelectric detection structure according to claim 1, characterized in that the photoelectric detection structure further comprises a second visible light sensor located in a lower layer of the second scintillator layer and used for converting visible light penetrating through the second scintillator layer into charges and storing the charges into the second visible light sensor.

10. A preparation method for the photoelectric detection structure according to claim 1, characterized in that the method at least comprises:
providing a substrate, preparing all material layers layer by layer on the substrate to form a first visible light sensor, forming a first scintillator layer on a first surface of the first visible light sensor and then forming a second scintillator layer on a second surface of the first visible light sensor.

11. The method according to claim 10, characterized in that the first scintillator layer and the second scintillator layer are bonded to the surfaces of the first visible light sensor through optical coupling adhesive.

12. The method according to claim 10, characterized in that the first scintillator layer and the second scintillator layer are formed by means of film coating.
